(19) United States
(12) Patent Application Publication
(10) Pub. No.: US 2026/0281278 A1
(43) Pub. Date: Sep. 17, 2026

(54) STORAGE MEDIUM, MEETING SUPPORT METHOD, AND MEETING SUPPORT SYSTEM FOR FACILITATING UNDERSTANDING OF MEETING CONTENT

(71) Applicant: CANON KABUSHIKI KAISHA, Tokyo (JP)

(72) Inventors: JUN TANAKA, Ibaraki (JP); RYUTA UEDA, Tokyo (JP)

(21) Appl. No.: 19/530,881

(22) Filed: Feb. 5, 2026

(30) Foreign Application Priority Data
Mar. 17, 2025 (JP) 2025-042475

(51) Int. Cl. H04N 7/15; G06V 10/25

(52) U.S. Cl. CPC H04N 7/152; G06V 10/25

(57) ABSTRACT

A non-transitory computer-readable storage medium stores a computer program that, when executed by a computer, causes the computer to function as a meeting support system. The meeting support system is configured to acquire a moving image of a meeting and audio from meeting participants as meeting information and extract a topic of the meeting from the acquired meeting information based on the movement of a pointer in the moving image. The meeting support system is also configured to identify each of image regions included in the moving image as a region of interest based on the extracted topic. The meeting support system is further configured to extract, from the content of the audio and the image regions at the playback time of the region of interest, related information related to the region of interest and generate correspondence information in which the region of interest is associated with the related information.

### BACKGROUND

### Field of the Technology

The present disclosure relates to a storage medium, a control method, and a meeting support system.

### Description of the Related Art

In recent years, web meetings (online meetings) in which a plurality of participants can participate via the Internet have become known. Each participant can join a web meeting through an information processing terminal. A participant can speak using a microphone connected to the information processing terminal. A participant can also show their image to other participants using a camera connected to the information processing terminal. In addition, in a web meeting, one participant can share a screen displayed on the participant’s terminal with other participants, thereby allowing all participants to view the same screen.

Such web meetings can be recorded on any terminal. By playing back recorded meeting data, it is possible to review the meeting and perform related tasks.

Japanese Patent Application Laid-Open No. 2023-113052 discloses a technique in which the degree of attention of participants to a topic or utterance is calculated based on facial expressions, actions, and utterances of the participants in recorded data of a web meeting, and other recorded data having a similar degree of attention is identified.

However, in reviewing a meeting, it is inefficient to view the entire recorded data to grasp the content. Therefore, it is desirable to facilitate understanding of the content of the meeting.

### SUMMARY

Embodiments described herein are directed to technology that enables the content of a meeting to be readily understood.

In one embodiment, a non-transitory computer-readable storage medium stores a computer program that, when executed by a computer, causes the computer to function as a meeting support system. The computer program causes the computer to perform a meeting acquisition step of acquiring a moving image of a meeting and audio from meeting participants as meeting information and a topic extraction step of extracting a topic of the meeting from the acquired meeting information based on the movement of a pointer included in the moving image. The computer program further causes the computer to perform a region identification step of identifying each of a plurality of image regions included in the moving image as a region of interest based on the extracted topic. Additionally, the computer program causes the computer to perform a relationship extraction step of extracting, from the content of the audio and the image regions at the playback time of the region of interest, related information related to the region of interest and a correspondence generation step of generating correspondence information in which the region of interest is associated with the related information.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating a hardware configuration of a meeting support system according to a first embodiment.

FIG. 2 is a block diagram illustrating a software configuration of the meeting support system.

FIG. 3 is a screen diagram illustrating an example of a moving image included in meeting information.

FIG. 4 is a flowchart illustrating processing of meeting information in the first embodiment.

FIG. 5 is an explanatory diagram illustrating an example of a display of grouped correspondence information.

FIG. 6 is a flowchart illustrating a process of extracting regions of interest from meeting information in the first embodiment.

FIGS. 7A to 7D are explanatory diagrams illustrating examples of images cropped from frame images constituting a moving image through the process of FIG. 6.

FIG. 8 is a flowchart illustrating a process of extracting relationships of correspondence information in the first embodiment.

FIG. 9 is a flowchart illustrating a process of grouping correspondence information in the first embodiment.

FIGS. 10A to 10D are diagrams illustrating tables of correspondence information and their relationships in the first embodiment.

FIG. 11 is a flowchart illustrating a process of extracting a region of interest from meeting information according to a second embodiment.

FIG. 12 is a flowchart illustrating a process of extracting correspondence information from meeting information according to a third embodiment.

FIG. 13 is a block diagram illustrating a software configuration of a meeting support system according to a fourth embodiment.

FIG. 14 is a flowchart illustrating processing of meeting information in the fourth embodiment.

FIG. 15 is a block diagram illustrating a software configuration of an overall system according to a fifth embodiment.

FIG. 16 is a flowchart illustrating processing of meeting information in the fifth embodiment.

### DESCRIPTION OF THE EMBODIMENTS

Example embodiments will be described in detail with reference to the accompanying drawings. It should be noted that the following embodiments are provided for illustrative purposes only and are not intended to limit the scope of the disclosure. While multiple features are described in the embodiments, the disclosure is not limited to embodiments that incorporate all such features, and various combinations of these features may be contemplated as appropriate. Furthermore, in the drawings, like reference numerals designate like or corresponding components, and duplicative descriptions thereof are omitted to avoid redundancy.

### First Embodiment

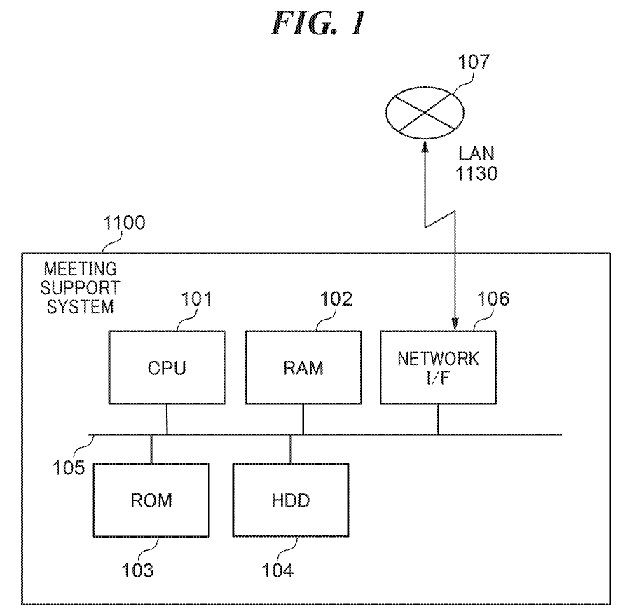

A first embodiment will be described below with reference to FIGS. 1 to 10D.

### Hardware Configuration of Meeting Support System

FIG. 1 is a block diagram illustrating a hardware configuration of a meeting support system according to a first embodiment. As illustrated in FIG. 1, a meeting support system 1100 serving as an information processing apparatus is connected to the Internet 107 via a network such as a LAN 1130. The meeting support system 1100 includes a CPU 101, a RAM 102, a ROM 103, a hard disk 104 (an example of an external storage device), and a network interface 106. The meeting support system 1100 may be implemented by, for example, a desktop personal computer. However, the meeting support system of this embodiment is not limited thereto, and a notebook personal computer, a tablet terminal, a smartphone, or the like may also be used.

The CPU 101 is a processor that executes programs and the like stored in the ROM 103 or the external storage device 104. Accordingly, the CPU 101 can implement respective steps (control method) described later. For example, the ROM 103 stores a program for causing a computer to operate as the meeting support system 1100. The CPU 101 also reads a control program stored in the hard disk 104 and executes the read control program using the RAM 102 as a work area.

The hard disk 104 stores a group of application programs, an operating system (OS), a plurality of types of trained models used as modules of the meeting support system, and the like. The hard disk 104 also stores recorded meeting data (hereinafter also referred to as “meeting information”) acquired via the Internet 107 through the network interface 106. Furthermore, the hard disk 104 stores data relating to summaries of meeting information processed by the CPU 101, and the like.

The network interface 106 is connected to the Internet 107 via the LAN line 1130. The network interface 106 controls input and output of information through the LAN line 1130.

### Configuration of Meeting Support System Centered on Software

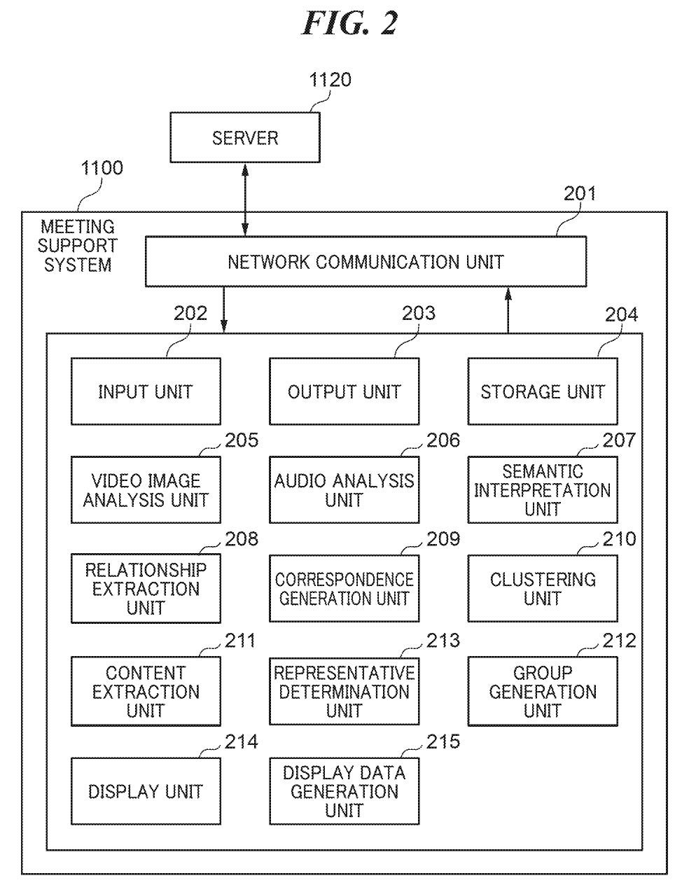

FIG. 2 is a block diagram illustrating a software configuration of the meeting support system. FIG. 2 mainly illustrates a functional configuration of the meeting support system 1100 serving as an information processing apparatus. A program for implementing the functions included in the meeting support system 1100 is stored in any of the RAM 102, the ROM 103, or the hard disk 104. The CPU 101 reads and executes the program, thereby implementing various functions of the meeting support system 1100. In the meeting support system 1100, software that implements various functions using a network or memory storage also operates. The meeting support system 1100 has functions of a network communication unit 201, an input unit 202, an output unit 203, a storage unit 204, an video image analysis unit 205, an audio analysis unit 206, a semantic interpretation unit 207, a relationship extraction unit 208, and a correspondence generation unit 209. The meeting support system 1100 further has functions of a clustering unit 210, a content extraction unit 211, a group generation unit 212, a representative determination unit 213, a display data generation unit 215, and a display unit 214.

The network communication unit 201 operates the network interface 106 to transmit and receive information via the LAN line 1130. The network communication unit 201 transmits and receives information to and from, for example, a server 1120 connected via the Internet 107.

The input unit 202 receives input information entered by a user who uses the meeting support system 1100 (meeting acquisition step). The input unit 202 also acquires meeting information from, for example, the server 1120 that stores web meeting information via the network communication unit 201. The output unit 203 receives a processing result obtained in accordance with the input information received by the input unit 202. The output unit 203 outputs the processing result to, for example, the server 1120 via the network communication unit 201. The storage unit 204 manages nonvolatile information in the meeting support system 1100. The storage unit 204 stores, as nonvolatile information, history information related to meeting information processed in the meeting support system 1100, various settings, and the like. The storage unit 204 also stores meeting information acquired by the input unit 202. In addition, the storage unit 204 stores processed information obtained by the video image analysis unit 205, the audio analysis unit 206, and the semantic interpretation unit 207 described below. The storage unit 204 stores the nonvolatile information in, for example, any of the hard disk 104, the RAM 102, or the ROM 103.

The video image analysis unit 205 analyzes the meeting information stored in the storage unit 204. The video image analysis unit 205 extracts text included in frame images of a moving image of the meeting information. The video image analysis unit 205 detects objects included in the frame images of the moving image of the meeting information. The objects detected by the video image analysis unit 205 include, for example, a mouse pointer, facial images of participants, graphs, and tables.

The audio analysis unit 206 analyzes the meeting information stored in the storage unit 204. The audio analysis unit 206 analyzes audio included in the meeting information and converts it into text. The semantic interpretation unit 207 interprets the meaning of the text and objects detected by the video image analysis unit 205. The semantic interpretation unit 207 also interprets the meaning contained in the data converted into text by the audio analysis unit 206. The term “semantic interpretation” as used herein refers to, for example, inputting the detected text and objects as explanatory variables into a predetermined trained language model to obtain, as an objective variable, content that describes the text and objects. The semantic interpretation unit 207 also extracts topics included in the text-converted data (topic extraction step). The semantic interpretation unit 207 calculates, for example, similarity for the text interpreted through semantic interpretation. The semantic interpretation unit 207 extracts, as a topic within a predetermined time, text that has a similarity equal to or greater than a predetermined threshold and that appears a predetermined number of times or more within the predetermined time. The video image analysis unit 205 may detect objects and text included in a moving image 301 by object detection and character detection. The semantic interpretation unit 207 may interpret the meaning contained in the detected objects and text. The video image analysis unit 205 may extract the interpreted meaning as a topic.

The video image analysis unit 205 identifies each of a plurality of image regions included in the moving image 301 as a region of interest based on the extracted topics (an example of region identification step). For example, the video image analysis unit 205 detects objects and text in each region included in the moving image 301 by object detection and character detection. For example, the semantic interpretation unit 207 inputs the detected text and objects as explanatory variables into a predetermined trained language model, thereby obtaining content that describes the text and objects as an objective variable. The video image analysis unit 205 identifies, as a region of interest, a region that includes objects and text having meanings related to the extracted topics based on the objects and text interpreted by the semantic interpretation unit 207. The video image analysis unit 205 may also identify, based on the movement of a mouse pointer or a pointer mark (pointer) of a presentation application included in the moving image 301, an image region of an object (including text) designated by the pointer. The semantic interpretation unit 207 may interpret the meaning of the object designated by the pointer and use the interpreted meaning as a topic. Examples of operations for designating an object by pointer movement include an operation of encircling an object included in the moving image 301, an operation of moving the pointer along text, and an operation of repeatedly moving the pointer between two objects.

The relationship extraction unit 208 extracts related information related to a region of interest from the content of audio and image regions at the playback time of the region of interest (relationship extraction step). The relationship extraction unit 208 extracts, as related information, summarized text data obtained by summarizing text data transcribed from audio data included in the playback time (playback time range) of the region of interest. The relationship extraction unit 208 may also use, as related information, information determined by the semantic interpretation unit 207 to have a high similarity in the moving image 301 outside the playback time included in the meeting information. Furthermore, the relationship extraction unit 208 may add, as related information, information determined to have a high similarity among other meeting information stored in the storage unit 204, which is different from that meeting information, or among other data acquired from the server 1120 via the network communication unit 201.

The correspondence generation unit 209 generates correspondence information in which a region of interest is associated with related information (correspondence generation step). For example, the correspondence generation unit 209 generates correspondence information in which related information is associated with a region of interest on a one-to-one basis. In other words, the correspondence information is generated by associating a summary of the region of interest with the region of interest. The relationship extraction unit 208 may extract a title (caption) of the correspondence information based on terms included in the related information. The relationship extraction unit 208 may use, as the title of the correspondence information, the term having the highest frequency of appearance among the terms included in the related information. The correspondence generation unit 209 may include the extracted title in the correspondence information.

The clustering unit 210 clusters the correspondence information according to the relevance (similarity) between one piece of correspondence information and another. For example, the clustering unit 210 includes two pieces of correspondence information having a high similarity in a single cluster. The content extraction unit 211 extracts content common to the pieces of correspondence information included in one cluster. The content extraction unit 211 adds the common content as tag information to each piece of correspondence information. The group generation unit 212 further subdivides the pieces of correspondence information included in one cluster into a plurality of groups based on the tags added by the content extraction unit 211. However, when all pieces of correspondence information included in one cluster have the same tag attached thereto, the group generation unit 212 may not subdivide the cluster and may leave it as a single group. The display data generation unit 215 creates data for displaying the grouped correspondence information. The display data generation unit 215 generates data for displaying the correspondence information for each group. The display unit 214 performs control to display the data of the correspondence information on, for example, a display (not illustrated).

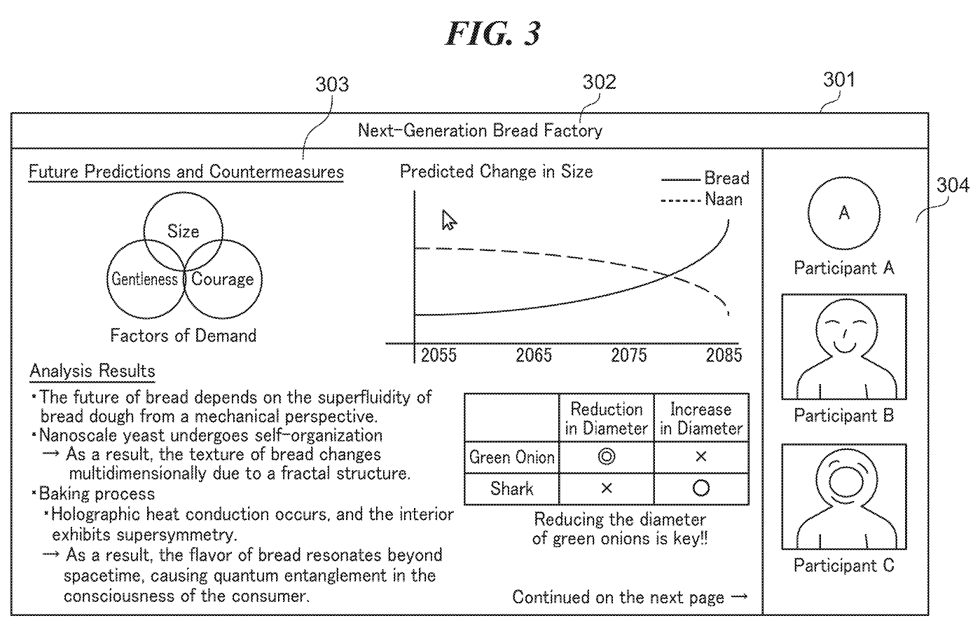

FIG. 3 is a screen diagram illustrating an example of a moving image included in meeting information. The screen illustrated in FIG. 3 is, for example, one frame image of the moving image included in the meeting information.

The moving image (frame image) 301 is included in recorded data that has been recorded as meeting information. In addition to the moving image (frame image) 301, the meeting information also includes text data transcribed from audio, participant information, associated attached files, and the like. The moving image (frame image) 301 includes a title display section 302 that displays a meeting title. The text included in the title display section 302 is a meeting name added by a user who held the web meeting to identify the meeting. The meeting name may be included not only in the moving image (frame image) 301 but also in the file name of the meeting information as text data. The moving image (frame image) 301 also includes a meeting screen 303 that displays a video that was commonly presented to the meeting participants. The meeting screen 303 is the screen that was presented to the meeting participants. The meeting screen 303 also includes a mouse pointer and a pointer mark of a presentation application. In this embodiment, the meeting screen 303 displays a Venn diagram, an explanation of the Venn diagram, a graph, a table, and a mouse pointer. The moving image (frame image) 301 further includes a participant display section 304 that displays information regarding the meeting participants. The participant display section 304 displays, for example, images of participants captured by a camera. The participant display section 304 may also display, for example, icons representing users.

### Processing of Meeting Information

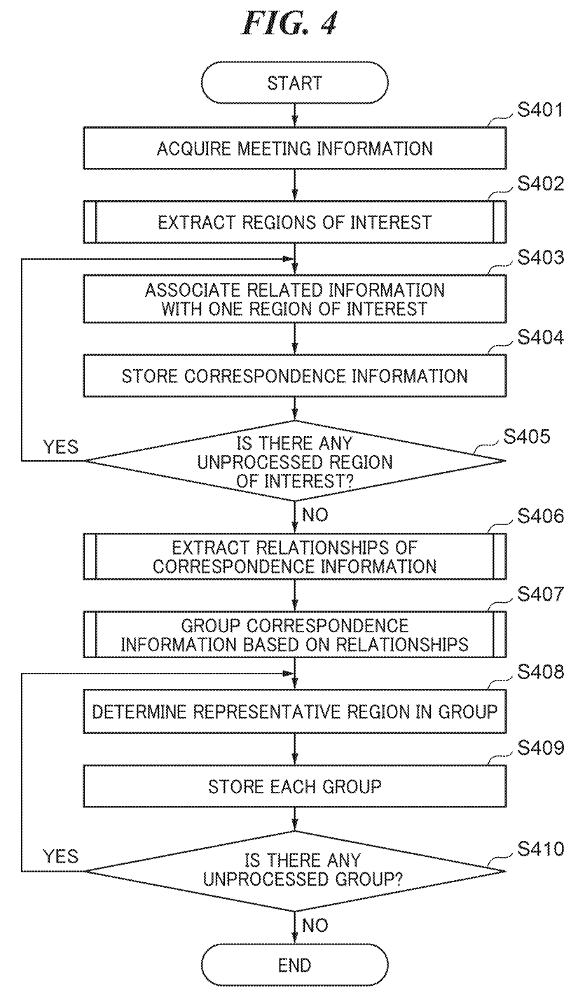

FIG. 4 is a flowchart illustrating processing of meeting information. The flow starts when the input unit 202 receives a request from a user to perform processing on meeting information. Upon receiving a request to perform processing on meeting information, the input unit 202 notifies the video image analysis unit 205 of the target meeting.

In step S401, the video image analysis unit 205 acquires meeting information from the storage unit 204. The video image analysis unit 205 acquires the meeting information corresponding to the meeting notified by the input unit 202.

In step S402, the video image analysis unit 205 acquires regions of interest from the meeting information. A region of interest refers to a portion of the moving image (meeting video) 301 that attracted participants’ attention during the meeting. Each region of interest is extracted from the moving image (meeting video) 301 as data including an image and time information indicating a period (from when to when) in the meeting.

In step S403, the relationship extraction unit 208 extracts related information to be added to the region of interest. The correspondence generation unit 209 then associates the extracted related information with the region of interest. The related information includes text data obtained by transcribing audio data included in the time period corresponding to the time (time information) during which the region of interest is displayed, or text data obtained by summarizing such transcribed text data using the semantic interpretation unit 207. The related information also includes information other than the moving image (meeting video) 301 contained in the meeting information, which is determined by the semantic interpretation unit 207 to have a high content similarity. The related information may further include other information stored in the storage unit 204 or information acquired via the network communication unit 201. The correspondence generation unit 209 generates correspondence information by associating the extracted related information with the corresponding region of interest. For example, the correspondence generation unit 209 may generate correspondence information by associating one piece of related information with one region of interest.

In step S404, the correspondence generation unit 209 stores the generated correspondence information in the storage unit 204.

In step S405, the video image analysis unit 205 determines whether there is any unprocessed region of interest. If there is an unprocessed region of interest, the process returns to step S403. When a plurality of regions of interest are present in a frame image, the video image analysis unit 205 determines that there is an unprocessed region of interest, and the process returns to step S403. In addition, when a plurality of pieces of related information correspond to a single region of interest, the process also returns to step S403 such that correspondence information is generated for each piece of related information.

Through the processing up to this point, information on regions of interest (correspondence information) can be extracted from the meeting information. Accordingly, by referring to the extracted regions of interest, partial referencing of meeting content becomes easier. The flow may also be terminated at this point, saving only the correspondence information. Furthermore, the subsequent processing steps may be performed by another device or at another timing.

In step S406, when it is determined that no unprocessed region of interest remains, the clustering unit 210 extracts relationships among the pieces of correspondence information. The clustering unit 210 extracts relationships according to the similarity between the pieces of correspondence information. The clustering unit 210 divides the pieces of correspondence information into clusters according to their similarity (clustering step).

In step S407, the group generation unit 212 groups the correspondence information based on the extracted relationships (group generation step). For example, the group generation unit 212 may group together pieces of correspondence information having a similarity equal to or greater than a predetermined threshold into a single group.

In step S408, the representative determination unit 213 determines, for each group created in step S407, representative information that serves as the representative of the group (representative determination step). The representative determination unit 213 determines, as the representative information, the piece of correspondence information among those included in the group that has the highest degree of relevance to the other pieces of correspondence information. The representative determination unit 213 also determines the region of interest included in the representative information as the representative region. For example, the representative determination unit 213 may determine, as the representative information, the piece of correspondence information that includes the region of interest having the longest playback time and may determine the region of interest included in that representative information as the representative region. In addition, the representative determination unit 213 may calculate a degree of similarity between the related information included in each piece of correspondence information and the related information included in the other pieces of correspondence information. The representative determination unit 213 may determine, as the representative information, the piece of correspondence information having the highest similarity to the other pieces of correspondence information and may determine the region of interest included in that representative information as the representative region. The representative determination unit 213 may also determine, as the representative information, the piece of correspondence information having the earliest playback start time and may determine the region of interest included in that correspondence information as the representative region. Furthermore, the representative determination unit 213 may determine, as the representative information, the piece of correspondence information that includes the region of interest having the highest degree of attention calculated by the semantic interpretation unit 207 and may determine the region of interest included in that correspondence information as the representative region. Here, when interpreting the meaning of text, the semantic interpretation unit 207 may calculate the degree of attention of the region of interest based on, for example, the frequency of occurrence of specific terms or phrases. The representative determination unit 213 adds identification information to the corresponding piece of correspondence information to distinguish the determined representative information from the other pieces of correspondence information. The identification information may be, for example, a flag indicating that the information is representative information.

In step S409, the representative determination unit 213 adds, to the generated group, a flag indicating the determined representative information. The representative determination unit 213 stores the group to which the flag has been added in the storage unit 204.

In step S410, the representative determination unit 213 determines whether there is any group for which a representative region has not yet been determined. If there is a group for which a representative region has not been determined, the process returns to step S408. On the other hand, if there is no group for which a representative region has not been determined, the process of this flowchart ends.

Through the processing described above, regions of interest can be extracted from the meeting information and stored in association with corresponding information. As a result, a portion of the meeting information can be easily referenced, and information related to that portion can also be easily accessed. In addition, by grouping the correspondence information through the processing from step S406 onward, it becomes possible to easily identify only the portions related to one of the regions of interest that have similar content. Since regions of interest having similar content form a cohesive group representing a single topic, the relationships among their contents can be readily understood. For example, regions of interest having similar content may form a group of multiple pieces of correspondence information related to a “Venn diagram.” By viewing the grouped pieces of correspondence information, the content related to the topic can be easily understood in a short time. The regions of interest processed from step S406 onward may be prepared by another device or by another method.

### Grouped Correspondence Information

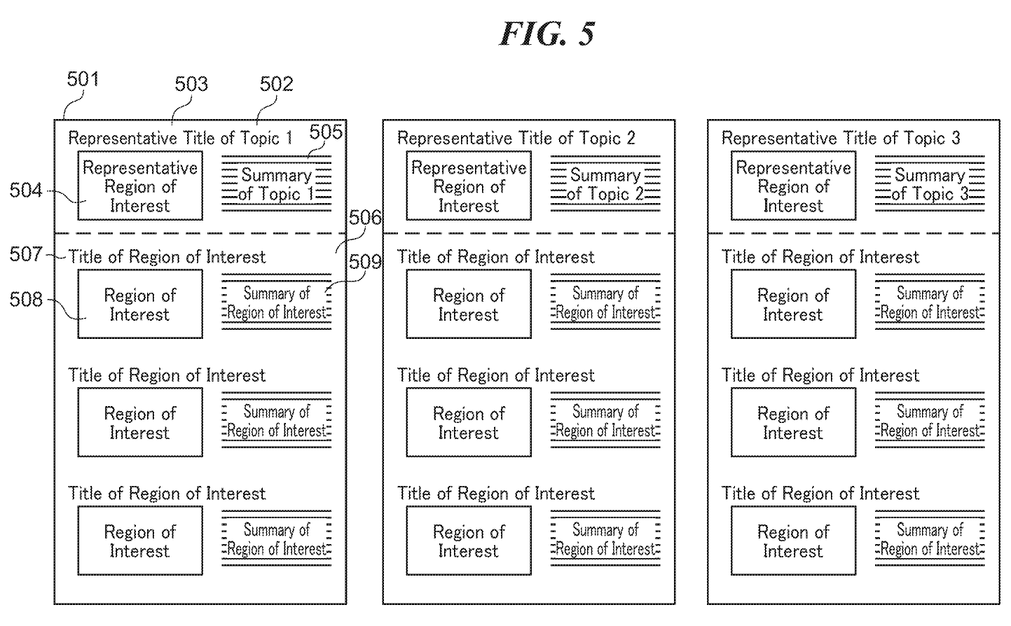

FIG. 5 is a diagram illustrating an example of a display of grouped correspondence information. The input unit 202 receives, for example, a request from a user to transmit display data for the grouped correspondence information. In response to the request to transmit display data, the output unit 203 displays, on a display (not illustrated), a screen such as that illustrated in FIG. 5.

A group display section 501 is a region that displays information relating to one of the groups created in step S407. In the example of FIG. 5, since three groups are present, three group display sections 501 are arranged. The group display sections 501 each include a representative region display section 502 and a region-of-interest display section 506. The representative region display section 502 displays one representative region of the group. For example, the representative region display section 502 is located at the uppermost position on the display. The region-of-interest display section 506 is located below the representative region display section 502. A plurality of pieces of correspondence information are displayed in the region-of-interest display section 506. The pieces of correspondence information included in the region-of-interest display section 506 are arranged, for example, in ascending order of playback time from top to bottom. All pieces of correspondence information included in the group are placed in the region-of-interest display section 506. As an example, the representative information of the group is located at the uppermost position on the display. The other pieces of correspondence information of the group are arranged below the representative information, listed downward in multiple rows. The other pieces of correspondence information of the group may be listed, for example, in ascending order of start time.

The representative region display section 502 is a region that displays the representative information of the group. The representative region display section 502 displays an image of the region of interest and the information associated therewith in step S403. Character information corresponding to the title of the region of interest, extracted from the summarized text data associated in step S403, is displayed in a representative region title display section 503. The representative region included in the representative information is displayed in a representative region image display section 504.

The summarized text data associated in step S403 is displayed in a representative region summary display section 505. In the example of FIG. 5, all of the text data is displayed in the representative region summary display section 505; however, only part of the text data may be displayed. All of the text data may alternatively be displayed through another method (for example, via mouse-over, or by a separate window that pops up upon clicking). In addition to the text data, the representative region summary display section 505 may also display the related information extracted by the relationship extraction unit 208.

The region-of-interest display section 506 is a region that displays information relating to correspondence information. Similarly to the representative region display section 502, the region-of-interest display section 506 includes a region-of-interest title display section 507, a region-of-interest image display section 508, and a region-of-interest summary display section 509, each corresponding to a respective piece of correspondence information. The region-of-interest title display section 507, the region-of-interest image display section 508, and the region-of-interest summary display section 509 are arranged for each piece of correspondence information. In this embodiment, the region-of-interest image display section 508 is arranged on the left side in the region-of-interest display section 506. The region-of-interest summary display section 509 is arranged to the right of the region-of-interest image display section 508 of the corresponding piece of correspondence information. The region-of-interest title display section 507 is displayed above the region-of-interest image display section 508. For example, the region-of-interest title display section 507 is arranged between the region-of-interest image display section 508 of the corresponding piece of correspondence information and that of another piece of correspondence information located above.

### Process of Extracting Regions of Interest

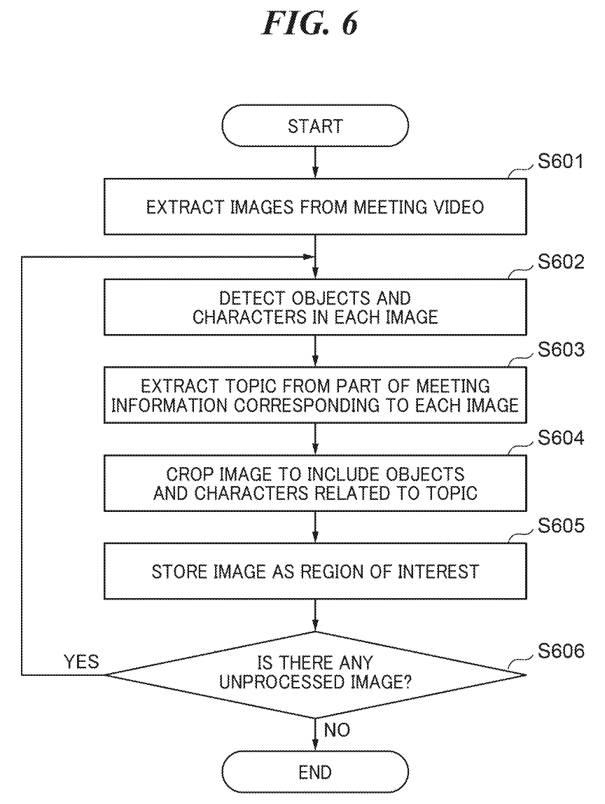

FIG. 6 is a flowchart illustrating a process of extracting regions of interest from meeting information in step S402 of FIG. 4.

In step S601, the video image analysis unit 205 first acquires images from the meeting information. Specifically, the video image analysis unit 205 acquires each frame image from the moving image (meeting video) 301. When there is little change between consecutive images, the video image analysis unit 205 regards a plurality of frame images as containing the same image. The video image analysis unit 205 uses a preset value as the threshold for determining whether there is a change. Alternatively, the video image analysis unit 205 may determine whether there is a change based on differences in object detection results within the images. The video image analysis unit 205 extracts an image contained in each region of the frame image.

In step S602, the video image analysis unit 205 performs object detection and character detection on each extracted image. For example, the video image analysis unit 205 identifies what kind of object the image represents through object detection. In addition, the video image analysis unit 205 detects text through character detection.

In step S603, the semantic interpretation unit 207 extracts topics within the playback time range from which the image is extracted. The audio analysis unit 206 converts audio data included in the meeting information into text data. The semantic interpretation unit 207 identifies what is discussed based on the converted text data. The video image analysis unit 205 may also function as a topic extraction unit. Separately from the extracted image, the video image analysis unit 205 acquires the movement of a mouse pointer or an application pointer within the moving image 301. The video image analysis unit 205 also extracts, as a topic, information about the portion indicated by the pointer (topic extraction step). For example, the video image analysis unit 205 detects the movement of the mouse pointer along a text image included in the moving image 301. The video image analysis unit 205 may identify the content contained in the text image as a topic based on the detected movement of the mouse pointer.

In step S604, the video image analysis unit 205 extracts a region that contains information corresponding to the topic extracted in step S603 from the images acquired in step S601, based on the content detected in step S602. In other words, the video image analysis unit 205 crops out the region as a region of interest.

In step S605, the video image analysis unit 205 stores the cropped image together with time information indicating the display period (display start time and display end time) of the image in the moving image 301, thereby saving it as a region of interest.

In step S606, the video image analysis unit 205 determines whether there is any unprocessed image. If there is an unprocessed image, the process returns to step S602. On the other hand, if there is no unprocessed image, the process of this flowchart ends.

### Examples of Extracted Images

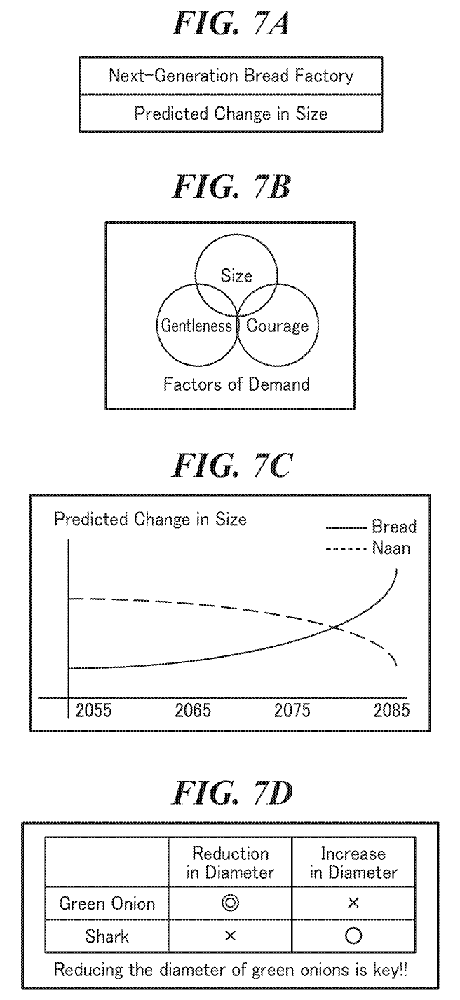

FIGS. 7A to 7D are explanatory diagrams illustrating examples of images cropped from frame images constituting a moving image through the process of FIG. 6. As an example, processing performed on the moving image 301 of FIG. 3 will be described below.

In the case of FIG. 7A, in step S603, the semantic interpretation unit 207 determines that the topic relates to the title. The video image analysis unit 205 crops the image so as to include the portion indicating the title.

In the case of FIG. 7B, in step S603, the semantic interpretation unit 207 determines that the topic relates to a Venn diagram and its content. The video image analysis unit 205 crops the image so as to include the portion indicating the Venn diagram.

In the case of FIG. 7C, in step S603, the video image analysis unit 205 determines that the topic relates to a graph based on the movement of the mouse pointer. The video image analysis unit 205 crops the image so as to include the portion indicating the graph.

In the case of FIG. 7D, in step S603, the semantic interpretation unit 207 determines that the topic relates to the word “green onion.” The video image analysis unit 205 crops the image so as to include the corresponding portion where the character string “green onion” was detected.

### Process of Extracting Relationships Between Regions of Interest

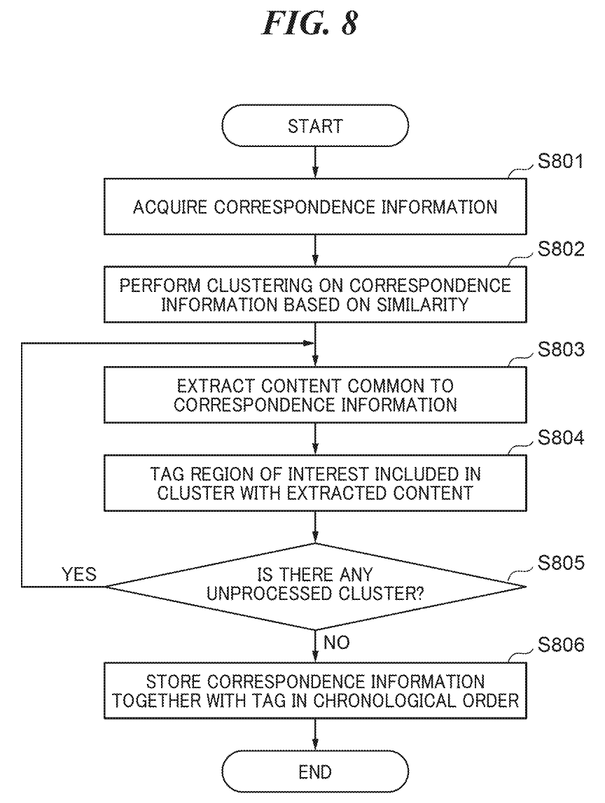

FIG. 8 is a flowchart illustrating a process of extracting relationships between regions of interest in step S406.

In step S801, the clustering unit 210 acquires the pieces of correspondence information stored in step S404. The clustering unit 210 acquires the correspondence information from the storage unit 204.

In step S802, the clustering unit 210 performs clustering on the acquired pieces of correspondence information based on the similarity of their contents (clustering step). The clustering unit 210 calculates, for any two pieces of correspondence information, a similarity score based on the contents processed by the semantic interpretation unit 207, where the score becomes higher as the meanings of the contents are closer. The group generation unit 212 clusters pieces of correspondence information that have a similarity equal to or greater than a predetermined threshold into a single cluster.

In step S803, the content extraction unit 211 extracts content that is common to the pieces of correspondence information included in one cluster (content extraction step). The content extraction unit 211 extracts, as the common content, the information that is commonly included in the related information of each piece of correspondence information and that has been determined by the semantic interpretation unit 207 to have the highest total degree of relevance to all the pieces of correspondence information.

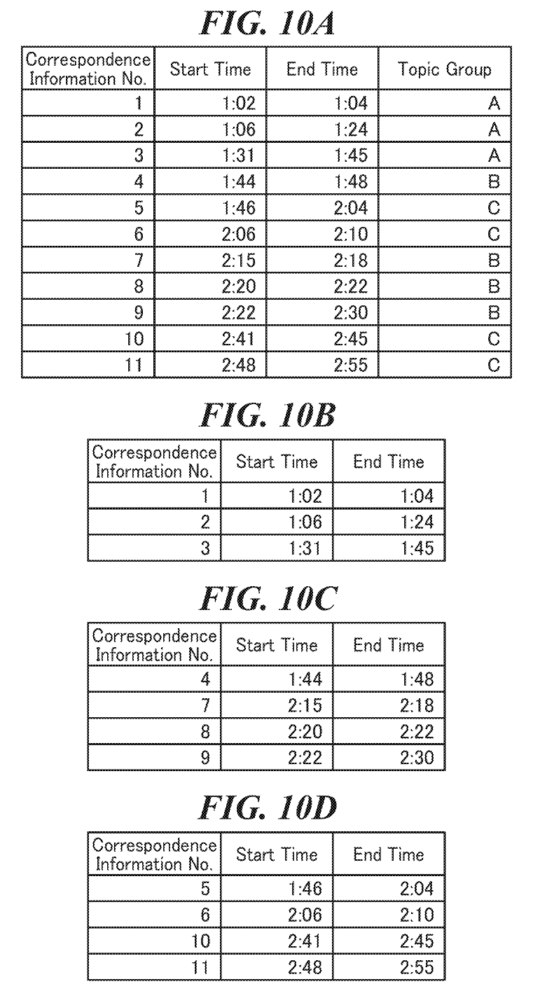

In step S804, the content extraction unit 211 tags the pieces of correspondence information included in one cluster with the content extracted in step S803. For example, as illustrated in FIG. 10A, the content extraction unit 211 adds tags such as A, B, and C, representing topic groups, to the respective pieces of correspondence information.

In step S805, the content extraction unit 211 determines whether there is any unprocessed cluster. If there is an unprocessed cluster, the process returns to step S803. On the other hand, if there is no unprocessed cluster, the process proceeds to step S806.

In step S806, the content extraction unit 211 stores the correspondence information together with the tag information in chronological order based on the time information included in the correspondence information.

### Process of Grouping Correspondence Information

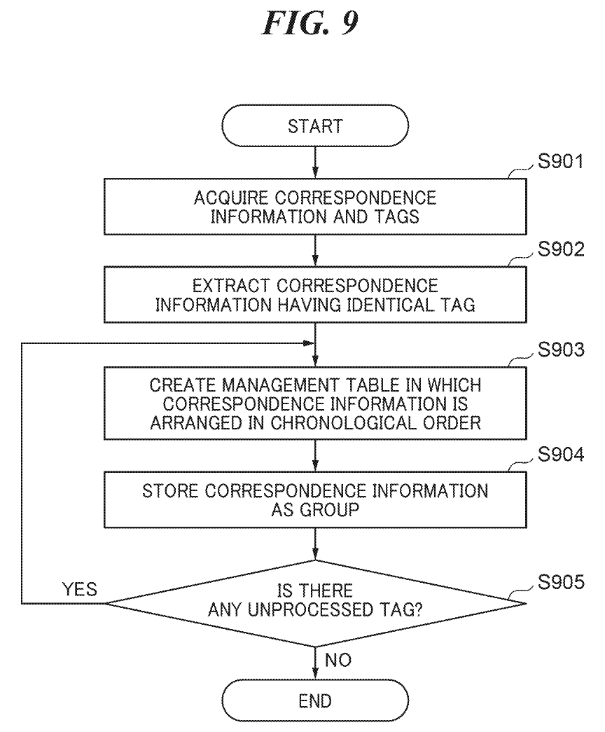

FIG. 9 is a flowchart illustrating a process of grouping correspondence information in step S407.

In step S901, the group generation unit 212 first acquires the relationships of the correspondence information stored in step S404. The group generation unit 212 acquires, as the relationships of the correspondence information, the correspondence information itself stored in step S806 together with the tag information added thereto.

In step S902, the group generation unit 212 extracts, from the relationships of the correspondence information acquired in step S901, pieces of correspondence information having the same tag.

In step S903, the group generation unit 212 creates a group that includes only the pieces of correspondence information having the same tag extracted in step S902. The group generation unit 212 sorts the pieces of correspondence information included in the group in ascending order of playback time.

In step S904, the group generation unit 212 stores the plurality of pieces of correspondence information sorted in step S903 as a single group. The group generation unit 212 stores the group in the storage unit 204.

In step S905, the group generation unit 212 determines whether there is any unprocessed tag. If there is an unprocessed tag, the process returns to step S903. On the other hand, if there is no unprocessed tag, the process of this flowchart ends.

### Correspondence Information Relationship Table

FIGS. 10A to 10D are diagrams illustrating tables of correspondence information and their relationships created in steps S406 and S407. FIG. 10A illustrates a table indicating relationships of pieces of correspondence information created through the processing in step S406. The correspondence information relationship table includes items such as an ID that uniquely identifies each piece of correspondence information, a start time, an end time, and a tag assigned to the piece of correspondence information. In this manner, the correspondence information is stored in ascending order of start time together with the assigned tags. This allows the progression of the meeting content to be referenced in chronological order.

FIGS. 10B, 10C, and 10D illustrate tables of groups created by further classifying the clusters of FIG. 10A through the processing in step S407. In each table, pieces of correspondence information having the same tag are extracted from the table of FIG. 10A and stored as correspondence information relating to the same topic. As a result, as illustrated in FIG. 5, only information relating to the same topic within the meeting can be collectively referenced.

### Process of Displaying Groups

Next, a process of displaying the created groups will be described. First, the input unit 202 receives an input of a display instruction for displaying a group (reception step). Next, the display data generation unit 215 generates display data to be displayed on a display device such as a display, based on the display instruction entered via the input unit 202 (display data generation step). As illustrated in FIG. 5, the display data generation unit 215 generates display data by arranging pieces of correspondence information downward in ascending order of start time, starting from the piece of correspondence information determined as the representative information. As also illustrated in FIG. 5, the display data generation unit 215 may generate display data that allows pieces of correspondence information belonging to a plurality of groups to be displayed side by side in the horizontal direction on the display device. The display unit 214 displays the generated display data on the display device (display step). As a result, the user can view the grouped correspondence information.

In addition, the created clusters may also be displayed. The display of clusters may be performed either before or after the groups are created. First, the input unit 202 receives an input of a display instruction for displaying a cluster (reception step). Next, the display data generation unit 215 generates display data to be displayed on a display device such as a display, based on the display instruction entered via the input unit 202 (display data generation step). As illustrated in FIG. 10A, the display data generation unit 215 generates display data by arranging a plurality of pieces of correspondence information that have been clustered into topic groups. The display data generation unit 215 arranges the pieces of correspondence information in the display data from top to bottom in ascending order of start time. In FIG. 10A, the pieces of correspondence information are arranged in ascending order from correspondence information No. 1 downward in the display data. The display unit 214 displays the generated display data on the display device (display step). As a result, the user can view the clustered correspondence information.

### Second Embodiment

A second embodiment will be described below, focusing primarily on differences from the first embodiment. In the first embodiment, as illustrated in the flowchart of FIG. 6, the video image analysis unit 205 extracts a region of interest based on the results of object detection in an image and a topic extracted from the meeting information. In the second embodiment, a region of interest is extracted by switching image detection models according to a topic extracted from the meeting information.

### Process of Extracting Regions of Interest

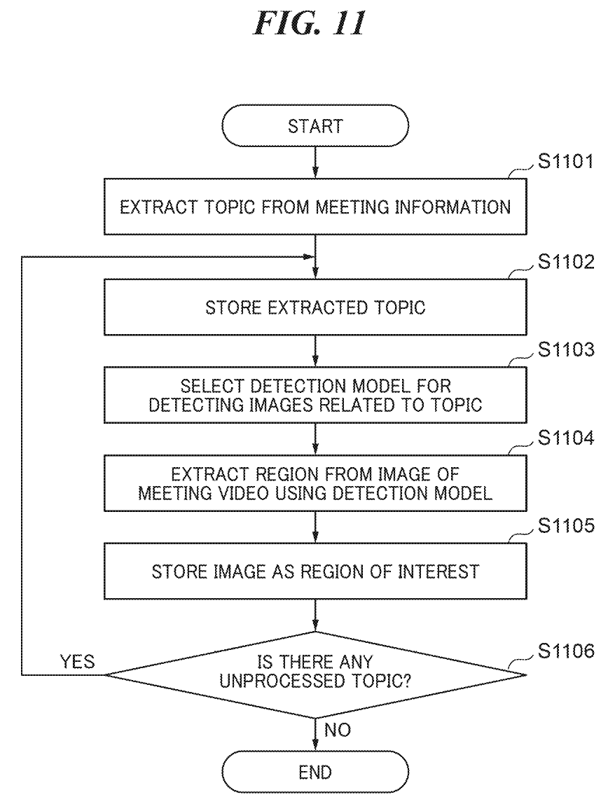

FIG. 11 is a detailed flowchart of the process performed in step S402 according to the second embodiment.

In step S1101, the semantic interpretation unit 207 first extracts a topic from the meeting information. The topic is extracted based on the content interpreted by the semantic interpretation unit 207 from audio and text data, in the same manner as in step S603. The video image analysis unit 205 may also extract a topic using a pointer within the moving image (meeting video) 301.

In step S1102, the semantic interpretation unit 207 stores the extracted topic in the storage unit 204.

In step S1103, the video image analysis unit 205 selects a detection model capable of detecting images related to the topic. In the example of FIG. 7B, the video image analysis unit 205 identifies, from the meeting information, that the topic relates to a Venn diagram, and selects a detection model capable of detecting Venn diagrams.

In step S1104, the video image analysis unit 205 performs region detection on images included in the moving image (meeting video) 301 using the detection model selected in step S1103 and crops the detected region as an image. Specifically, for example, the video image analysis unit 205 detects a region from the moving image (meeting video) 301, as illustrated in FIG. 7B, using the selected detection model capable of detecting Venn diagrams.

In step S1105, the video image analysis unit 205 stores the cropped image as a region of interest. The video image analysis unit 205 also stores, together with the region of interest, the time period during which the region was detected.

In step S1106, the video image analysis unit 205 determines whether there is any unprocessed topic. If there is an unprocessed topic, the process returns to step S1102. On the other hand, if there is no unprocessed topic, the process of this flowchart ends.

In the first embodiment, it is necessary to detect all objects and characters. In contrast, in the second embodiment, detection is targeted specifically at portions relevant to the topic, allowing a region of interest that better corresponds to the topic to be extracted.

### Third Embodiment

A third embodiment will be described below, focusing primarily on differences from the first and second embodiments. In the first embodiment, as illustrated in the flowchart of FIG. 6, a region of interest is extracted based on the results of object detection in an image and a topic extracted from the meeting information. In the second embodiment, a region of interest is extracted by switching image detection models according to a topic extracted from the meeting information. In the third embodiment, an image that may become a region of interest is first detected, and it is subsequently determined, from the meeting information, whether the image is appropriate as a region of interest.

### Process of Extracting Correspondence Information from Meeting Information

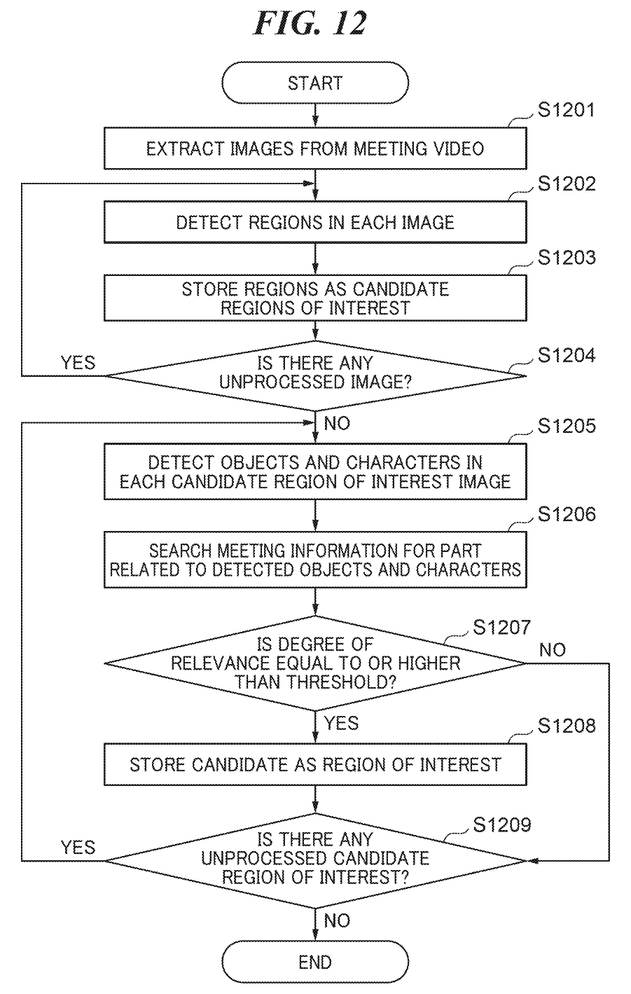

FIG. 12 is a detailed flowchart of the process performed in step S402 of FIG. 4 according to the third embodiment.

In step S1201, the video image analysis unit 205 extracts images from the meeting information. The video image analysis unit 205 extracts images by acquiring frame images from the moving image (meeting video) 301 in the same manner as in step S601. When there is little change between consecutive frame images, the video image analysis unit 205 extracts them as the same image.

In step S1202, the video image analysis unit 205 detects candidate regions of interest in the image. For detecting candidate regions of interest, the video image analysis unit 205 uses a detection model that has been trained on regions of interest. The detection model is created by training on ground-truth data in which a meeting video is used as input and regions that an operator perceived as being of interest are labeled as regions of interest. For example, this training corresponds to the topic extraction and region identification steps. In other words, the topic extraction and region identification steps employ a detection model trained to determine whether text and objects in the moving image 301 should be treated as regions of interest, with the moving image 301 of the meeting information serving as the explanatory variable and each candidate region of interest being output as the objective variable. In this manner, the video image analysis unit 205 detects, from the image alone, regions that may serve as candidates for regions of interest.

In step S1203, the video image analysis unit 205 stores the candidate regions of interest in the storage unit 204.

In step S1204, the video image analysis unit 205 determines whether there is any unprocessed image. If there is an unprocessed image, the process returns to step S1202. On the other hand, if there is no unprocessed image, the process proceeds to step S1205, in which the video image analysis unit 205 detects objects and characters included in each candidate region of interest image.

In step S1206, the video image analysis unit 205 searches the meeting information for information related to the objects and characters detected in step S1205.

In step S1207, the video image analysis unit 205 calculates the degree of relevance of the candidate region of interest to the meeting based on the content searched for in step S1206 and determines whether the degree of relevance is equal to or higher than a preset threshold. If the degree of relevance is lower than the threshold, the process proceeds to step S1209. On the other hand, if the degree of relevance is equal to or higher than the threshold, the process proceeds to step S1208, in which the video image analysis unit 205 stores the candidate region of interest as a region of interest. The video image analysis unit 205 determines the time information to be stored together with the region of interest based on the time period during which the region was detected in the moving image (meeting video) 301 and the content searched for in step S1206.

In step S1209, the video image analysis unit 205 determines whether there is any unprocessed candidate region of interest. If there is an unprocessed candidate region of interest, the process returns to step S1205. On the other hand, if there is no unprocessed candidate region of interest, the process of this flowchart ends.

In the third embodiment, detection is performed using a model that identifies images serving as candidate regions of interest, and whether each candidate should be stored as a region of interest is determined based on its degree of relevance to the meeting. Accordingly, by adjusting the threshold, the number of regions of interest to be stored can be controlled. This allows more regions of interest to be stored for meetings that the user considers important, while reducing the number of regions of interest to be stored for less important meetings, thereby saving storage capacity.

### Fourth Embodiment

A fourth embodiment will be described below, focusing primarily on differences from the first to third embodiments. In the fourth embodiment, a large language model (LLM) is used to extract regions of interest and obtain relationships among the regions of interest.

An LLM is a natural language processing model trained on a large amount of text data, image data, and/or video data, and it takes text as input and outputs text. Some large language models are also capable of accepting image data or video data as input. In an LLM, the text provided as input is referred to as a “prompt.”

### Software Configuration of Meeting Support System

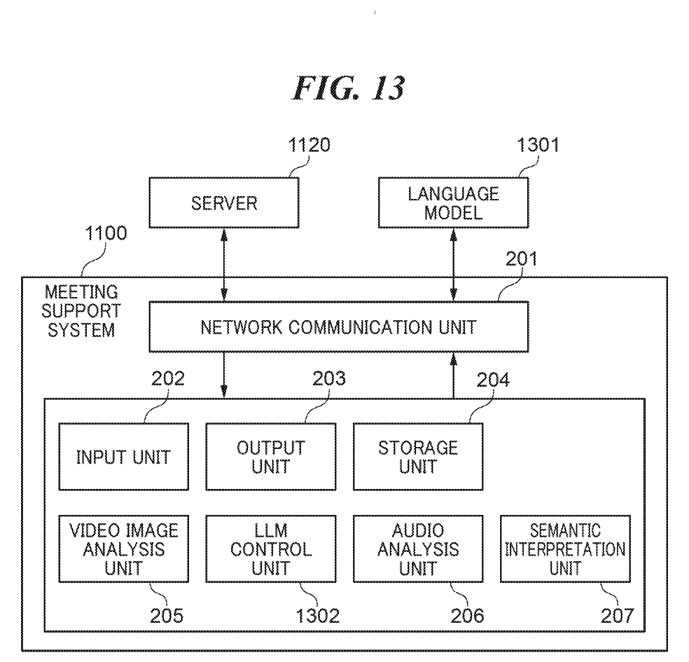

FIG. 13 is a diagram illustrating a software configuration of the overall system according to the fourth embodiment.

The meeting support system 1100 is connected to an LLM control unit 1302 via a network such as the LAN 1130. An LLM operates on the LLM control unit 1302, and input to the LLM is performed by transmitting prompts, image data, or video data thereto. The processing performed by the LLM control unit 1302 corresponds to the topic extraction step, the region identification step, the relationship extraction step, the correspondence generation step, and the group generation step.

The LLM control unit 1302 generates data including prompts to be input to the LLM and performs input/output processing to and from a language model 1301 via the network communication unit 201.

### Processing of Meeting Information

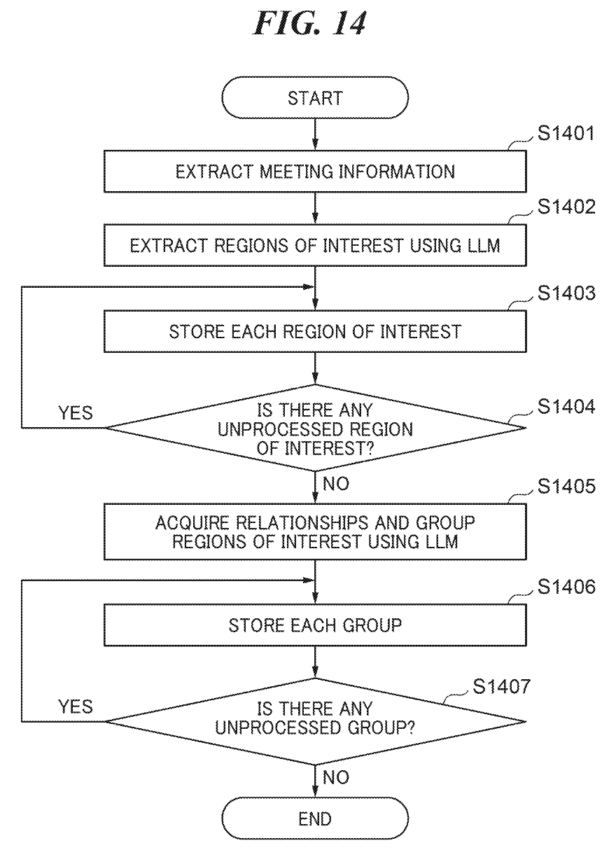

FIG. 14 is a flowchart illustrating processing performed by the video image analysis unit 205 upon receiving a request to perform processing on meeting information through the input unit 202. Having received a request to perform processing on meeting information, the input unit 202 notifies the video image analysis unit 205 of the target meeting. The video image analysis unit 205 and the LLM control unit 1302 perform the following processing based on the instruction.

In step S1401, the video image analysis unit 205 acquires meeting information from the storage unit 204.

In step S1402, the LLM control unit 1302 acquires regions of interest and corresponding information from the meeting information. The video image analysis unit 205 inputs the meeting information together with a prompt to the LLM of the LLM control unit 1302, whereby the LLM control unit 1302 acquires regions of interest based on information output from the LLM. The prompt may be, for example, entered by the user through the input unit 202. Having received the meeting information from the video image analysis unit 205, the LLM control unit 1302 generates a prompt that instructs the extraction of regions of interest from the moving image (meeting video) 301 contained in the meeting information. The LLM control unit 1302 then inputs the prompt to the LLM together with other meeting information (topic extraction step and region identification step).

In step S1403, the LLM control unit 1302 stores one of the regions of interest in the storage unit 204.

In step S1404, the LLM control unit 1302 determines whether there is any unprocessed region of interest. If there is an unprocessed region of interest, the process returns to step S1403. On the other hand, if there is no unprocessed region of interest, the process proceeds to step S1405, in which the LLM control unit 1302 acquires relationships from the regions of interest and performs group generation (relationship extraction step, correspondence generation step, and group generation step). The video image analysis unit 205 inputs all the regions of interest extracted in step S1402 to the LLM, thereby performing acquisition of relationships and creation of groups. Upon receiving an instruction from the video image analysis unit 205 to acquire relationships, the LLM control unit 1302 creates a prompt for acquiring relationships among the regions of interest. For example, the LLM control unit 1302 inputs the regions of interest stored in the storage unit 204 to the LLM together with the prompt, thereby acquiring relationships among the regions of interest. The prompt also includes an instruction to determine representative information (representative region). The LLM control unit 1302 determines the representative information (representative region) in accordance with the prompt.

In step S1406, the LLM control unit 1302 stores the group information in the storage unit 204.

In step S1407, the LLM control unit 1302 determines whether there is any unprocessed group. If there is an unprocessed group, the process returns to step S1406. On the other hand, if there is no unprocessed group, the process of this flowchart ends.

This makes it possible to extract regions of interest and acquire their relationships without using separate detection models or calculating degrees of relevance.

In the fourth embodiment, an LLM is used for extracting regions of interest in step S1402 and for acquiring relationships among regions of interest in step S1405. However, the processing of step S1402 can also be implemented as the processing of S402 in the first to third embodiments. Furthermore, the processing of step S1402 may be used as is, while the processing of step S1405 may be implemented as the processing of steps S406 and S407 in the first embodiment.

### Fifth Embodiment

A fifth embodiment will be described below, focusing primarily on differences from the first to fourth embodiments. In the fourth embodiment, an LLM is used for extracting regions of interest and for acquiring the relationships among the regions of interest. In contrast, in the fifth embodiment, both of these operations are performed simultaneously by the LLM.

### Software Configuration of Meeting Support System

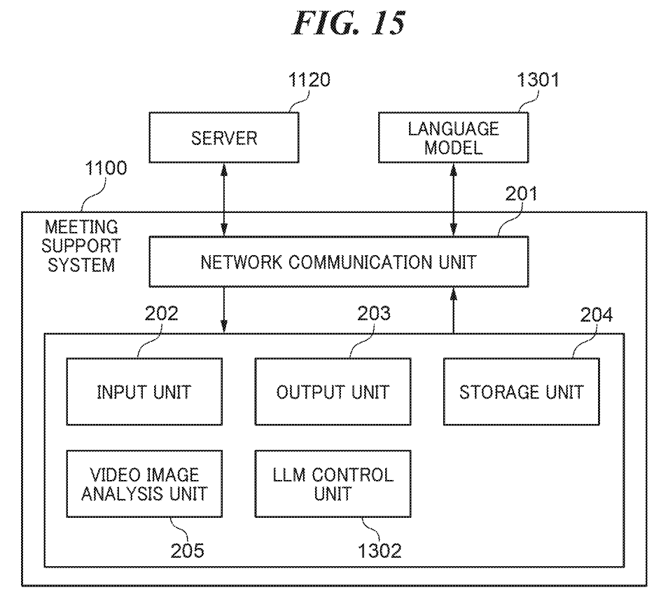

FIG. 15 is a diagram illustrating a software configuration of the overall system according to the fifth embodiment. As in the fourth embodiment, the meeting support system 1100 is connected to, and includes, the LLM control unit 1302. However, since the extraction of regions of interest and the acquisition of their relationships are performed entirely by the LLM, the system does not include the audio analysis unit 206 and the semantic interpretation unit 207.

### Processing of Meeting Information

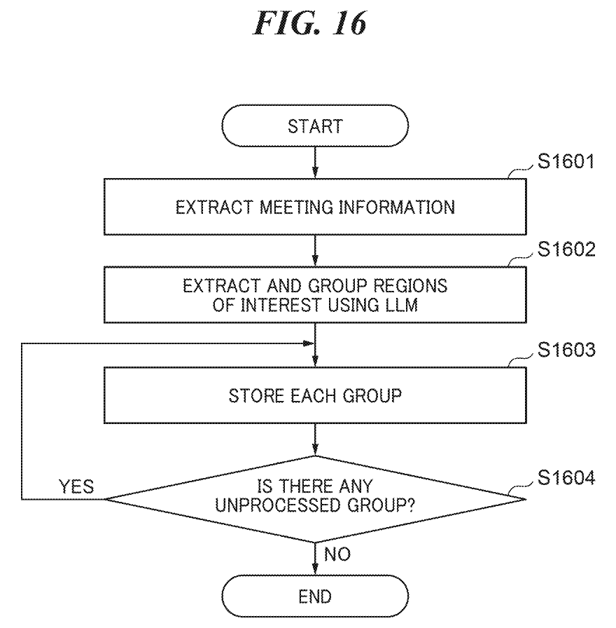

FIG. 16 is a flowchart illustrating processing performed by the video image analysis unit 205 upon receiving a request to perform processing on meeting information through the input unit 202. Having received a request to perform processing on meeting information, the input unit 202 notifies the video image analysis unit 205 of the target meeting. The video image analysis unit 205 performs the following processing in response to the instruction.

In step S1601, the video image analysis unit 205 acquires meeting information from the storage unit 204.

In step S1602, the video image analysis unit 205 performs extraction of regions of interest and acquisition of their relationships through the LLM control unit 1302. When instructed by the video image analysis unit 205 to extract regions of interest and acquire their relationships, the LLM control unit 1302 generates a prompt. In order to instruct the LLM to extract regions of interest and acquire their relationships, the prompt includes content that instructs the creation of a management table such as those illustrated in FIGS. 10A to 10D. The LLM control unit 1302 inputs the meeting information and the prompt to the LLM, thereby causing the LLM to output the relationships among regions of interest as illustrated in FIGS. 10A to 10D.

In step S1603, the video image analysis unit 205 stores the group information in the storage unit 204.

In step S1604, the video image analysis unit 205 determines whether there is any unprocessed group. If there is an unprocessed group, the process returns to step S1603. On the other hand, if there is no unprocessed group, the process of this flowchart ends.

This enables extraction of regions of interest and acquisition of their relationships with a configuration simpler than that of the fourth embodiment.

According to the embodiments described above, it is possible to provide technology that enables the content of a meeting to be readily understood.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-042475, filed March 17, 2025, which is hereby incorporated by reference herein in its entirety.

What is claimed is:

1. A non-transitory computer-readable storage medium storing a computer program that, when executed by a computer of an information processing apparatus, causes the computer to perform:
a meeting acquisition step of acquiring a moving image of a meeting and audio from meeting participants as meeting information;
a topic extraction step of extracting a topic of the meeting from the acquired meeting information based on movement of a pointer included in the moving image;
a region identification step of identifying each of a plurality of image regions included in the moving image as a region of interest based on the extracted topic;
a relationship extraction step of extracting, from content of the audio and the image regions at a playback time of the region of interest, related information related to the region of interest; and
a correspondence generation step of generating correspondence information in which the region of interest is associated with the related information.

2. The non-transitory computer-readable storage medium according to claim 1, wherein
the region identification step includes identifying a playback time of an image region corresponding to the region of interest; and
the relationship extraction step includes extracting the related information from content of the audio and the image region at the identified playback time.

3. The non-transitory computer-readable storage medium according to claim 1, wherein the topic extraction step includes analyzing the audio and extracting the topic of the meeting included in the audio.

4. The non-transitory computer-readable storage medium according to claim 1, wherein the topic extraction step includes extracting the topic from text included in the moving image.

5. The non-transitory computer-readable storage medium according to claim 1, wherein
the topic extraction step includes designating an image region that includes an object indicated by the pointer based on the movement of the pointer in the moving image; and
the region identification step includes identifying the designated image region as the region of interest.

6. The non-transitory computer-readable storage medium according to claim 1, wherein the correspondence generation step includes extracting a title of the correspondence information from the related information and generating the correspondence information that includes the extracted title.

7. The non-transitory computer-readable storage medium according to claim 1, wherein
the correspondence information includes a plurality of pieces of correspondence information; and
the computer program further causes the computer to perform, after the correspondence generation step, a clustering step of clustering the pieces of correspondence information into clusters according to similarity among the pieces of correspondence information.

8. The non-transitory computer-readable storage medium according to claim 7, wherein the computer program further causes the computer to perform, after the clustering step:
a content extraction step of extracting content that is common to the pieces of correspondence information included in each of the clusters; and
a group generation step of further classifying the pieces of correspondence information included in one cluster based on the extracted content to generate groups.

9. The non-transitory computer-readable storage medium according to claim 8, wherein the computer program further causes the computer to perform, after the group generation step, a representative determination step of determining representative information that represents the pieces of correspondence information included each of the groups.

10. The non-transitory computer-readable storage medium according to claim 1, wherein the region identification step includes:
selecting an appropriate detection model according to the topic from detection models prepared in advance for individual topics; and
inputting the topic to the selected detection model to identify the region of interest.

11. The non-transitory computer-readable storage medium according to claim 1, wherein
a detection model is used in the topic extraction step and the region identification step; and
the detection model is configured to extract an image region included in the moving image as the topic and to determine whether the image region is to be the region of interest to identify the region of interest.

12. The non-transitory computer-readable storage medium according to claim 8, wherein
in the topic extraction step and the region identification step, a prompt for extracting the topic and the meeting information are input to a large language model to identify the region of interest;
in the relationship extraction step and the correspondence generation step, a prompt for extracting the related information related to the identified region of interest and the identified region of interest are input to the large language model to perform extraction of the related information and generation of the correspondence information; and
in the clustering step, the content extraction step, and the group generation step, a prompt for grouping the pieces of correspondence information and the pieces of correspondence information are input to the large language model to group the pieces of correspondence information.

13. The non-transitory computer-readable storage medium according to claim 12, wherein, in the topic extraction step, the region identification step, the relationship extraction step, the correspondence generation step, and the clustering step, a prompt for performing identification of the regions of interest, extraction of the related information, generation of the correspondence information, and clustering of the pieces of correspondence information, together with the meeting information, is input to the large language model to perform clustering of the pieces of correspondence information.

14. The non-transitory computer-readable storage medium according to claim 7, wherein
the computer program further causes the computer to perform, after the clustering step:
a reception step of receiving an input of a display instruction for displaying the clusters;
a display data generation step of generating display data for the clusters; and
a display step of displaying the display data for the clusters; and
the display data generation step includes generating display data for each cluster in which the pieces of correspondence information included in the cluster are arranged in chronological order.

15. The non-transitory computer-readable storage medium according to claim 9, wherein
the computer program further causes the computer to perform, after the group generation step:
a reception step of receiving an input of a display instruction for displaying the groups;
a display data generation step of generating display data for the groups; and
a display step of displaying the display data for the groups; and
the display data generation step includes generating display data for each group in which the pieces of correspondence information included in the group are arranged in chronological order starting from the representative information.

16. A meeting support method comprising:
acquiring a moving image of a meeting and audio from meeting participants as meeting information;
extracting a topic of the meeting from the acquired meeting information based on movement of a pointer included in the moving image;
identifying each of a plurality of image regions included in the moving image as a region of interest based on the extracted topic;
extracting, from content of the audio and the image regions at a playback time of the region of interest, related information related to the region of interest; and
generating correspondence information in which the region of interest is associated with the related information.

17. A meeting support system comprising:
one or more processors; and
at least one memory coupled to the one or more processors and storing instructions that, when executed by the one or more processors, cause the one or more processors to perform operations comprising:
acquiring a moving image of a meeting and audio from meeting participants as meeting information;
extracting a topic of the meeting from the acquired meeting information based on movement of a pointer included in the moving image;
identifying each of a plurality of image regions included in the moving image as a region of interest based on the extracted topic;
extracting, from content of the audio and the image regions at a playback time of the region of interest, related information related to the region of interest; and
generating correspondence information in which the region of interest is associated with the related information.
